(19) United States
(12) Patent Application Publication
(10) Pub. No.: US 2023/0354947 A1
(43) Pub. Date: Nov. 9, 2023

(54) ARTICLE INCLUDING RECYCLED THERMOPLASTIC MATERIAL

(71) Applicants: Romesh Patel, Lafayette, CA (US); James Romero, San Francisco, CA (US); Daehwi Lim, Gimhae City (KR)

(72) Inventors: Romesh Patel, Lafayette, CA (US); James Romero, San Francisco, CA (US); Daehwi Lim, Gimhae City (KR)

(21) Appl. No.: 18/143,958

(22) Filed: May 5, 2023

Related U.S. Application Data
(60) Provisional application No. 63/338,844, filed on May 5, 2022.

(51) Int. Cl. A43B 1/00; A43B 21/20; A43B 13/04; A43B 1/14

(52) U.S. Cl. CPC A43B 1/0063; A43B 21/20; A43B 13/04; A43B 1/14

(57) ABSTRACT

A shoe including a component formed at least in part from a recycled thermoplastic material is disclosed. The recycled thermoplastic material may be derived from scrap material from an operation of making another component of the shoe. The recycled thermoplastic material may be derived at least in part from scrap thermoplastic foam from an operation of making a sole component of the shoe, but the shoe component including the recycled thermoplastic material may have a density greater than that of the sole component. Both shoe components may be bio-based. Methods for making shoe components including the recycled thermoplastic material are also disclosed.

### CROSS-REFERENCE TO RELATED APPLICATION(S)

This application is a nonprovisional application of and claims the benefit of U.S. Provisional Patent Application No. 63/338,844, filed May 5, 2022, and titled “Bio-based Article Including Recycled Thermoplastic Polymer Material,” the disclosure of which is hereby incorporated herein by reference in its entirety.

### FIELD

The described embodiments relate generally to an article including a recycled thermoplastic material and related methods. More particularly, the present embodiments relate to an article for a shoe, a shoe including the article, and methods for making the recycled thermoplastic material, the article, and the shoe.

### SUMMARY

The disclosure provides articles including a recycled thermoplastic material. The recycled thermoplastic material may be formed from scrap thermoplastic material from an operation of making another article. In some cases, the article is a component for a shoe and the scrap thermoplastic material may result from an operation of making another component of the shoe. The articles including the recycled thermoplastic material may be bio-based and shoes including the articles are also provided. The disclosure further provides methods for making the recycled thermoplastic material, methods for making the articles, and methods for making shoes including the articles.

In some cases, the recycled scrap thermoplastic material may be formed wholly or in part from a foam and the article including the recycled thermoplastic material may be dense. Therefore, the methods described herein for making an article including a recycled thermoplastic material can take a foam waste stream and change its form. As a particular example, the scrap thermoplastic material may be generated by an operation of making a foam sole component and the methods described herein may be used to make a dense heel counter.

The bio-based articles disclosed herein and shoes including these bio-based articles can have reduced environmental impacts as compared to some conventional thermoplastic articles. For example, the environmental impact of a process for producing the bio-based article can be reduced both because the article includes a recycled thermoplastic material and because that recycled thermoplastic material is derived at least in part from a bio-based thermoplastic material. The bio-based thermoplastic material may be derived in turn from one or more renewable resources, such one or more plant sources.

The environmental impact can be further reduced when at least some of the bio-based thermoplastic material is sourced from scrap material from another manufacturing operation. In some cases, the bio-based article is a part for a shoe, and the bio-based thermoplastic material may be sourced at least in part from scrap material from an operation for manufacturing another part for the shoe. As an example, the bio-based article is a heel counter and at least some of the bio-based thermoplastic material used to make the heel counter is provided by scrap foam from a molding process for manufacturing a midsole for the shoe.

One measure of the environmental impact of a product is the carbon footprint for the product, which can be characterized by the carbon dioxide equivalent (CO₂e). In the case of the bio-based article, the carbon footprint can be reduced by including a polymer material that is at least in part plant-based and that is recycled. The carbon footprint for a shoe including a bio-based foam midsole can be reduced by using recycled foam scrap from a midsole molding operation to make a bio-based heel counter or another bio-based part of the shoe.

The disclosure provides a shoe comprising an upper portion, a sole having a top surface that is attached to the upper portion, the sole comprising a foam component formed from a bio-based thermoplastic material, and a heel counter attached to an exterior surface of the upper portion and comprising a recycled bio-based thermoplastic material.

The disclosure also provides a shoe comprising an upper portion, a sole having a top surface that is attached to the upper portion, the sole comprising a foam component formed of a thermoplastic elastomer, and a heel counter attached to an exterior surface of the upper portion and formed at least in part from scrap thermoplastic elastomer.

The disclosure also provides a method comprising producing a recycled scrap thermoplastic material and forming a shoe component from a feedstock including the recycled scrap thermoplastic material.

### BRIEF DESCRIPTION OF THE DRAWINGS

The disclosure will be readily understood by the following detailed description in conjunction with the accompanying drawings, wherein like reference numerals designate like elements.

FIG. 1A shows a right side view of a shoe.

FIG. 1B shows a left side view of a shoe.

FIG. 2 shows a view of a heel counter.

FIG. 3 shows a flow chart of a process for making a shoe component.

FIG. 4 shows a flow chart of a process for producing a recycled scrap thermoplastic material.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The disclosure provides articles including a recycled thermoplastic material. The recycled thermoplastic material may be formed from scrap thermoplastic material from an operation of making another article. In some cases, the article is a component for a shoe, and the scrap thermoplastic material may result from an operation of making another component of the shoe. The articles including the recycled thermoplastic material may be bio-based and shoes including the articles are also provided. The disclosure further provides methods for making the recycled thermoplastic material, methods for making the articles, and methods for making shoes including the articles.

In some cases, the recycled scrap thermoplastic material may be formed wholly or in part from a foam and the article including the recycled thermoplastic material may be dense or substantially dense. Therefore, the methods described herein for making an article including a recycled thermoplastic material can take a foam waste stream and change its form. As a particular example, the scrap thermoplastic material may be generated by an operation of making a foam sole component and the methods described herein may be used to make a dense or substantially dense heel counter.

The bio-based articles disclosed herein and shoes including these bio-based articles can have reduced environmental impacts as compared to some conventional thermoplastic articles. For example, the environmental impact of a process for producing the bio-based article can be reduced both because the article includes a recycled thermoplastic material and because that recycled thermoplastic material is derived at least in part from a bio-based thermoplastic material. The bio-based thermoplastic material may be derived in turn from one or more renewable resources, such one or more plant sources.

The environmental impact can be further reduced when at least some of the bio-based thermoplastic material is sourced from scrap material from another manufacturing operation. In some cases, the bio-based article is a part for a shoe and the bio-based thermoplastic material may be sourced at least in part from scrap material from an operation for manufacturing another part for the shoe. As an example, the bio-based article is a heel counter and at least some of the bio-based thermoplastic material used to make the heel counter is provided by scrap foam from a molding process for manufacturing a midsole for the shoe.

One measure of the environmental impact of a product is the carbon footprint for the product, which can be characterized by the carbon dioxide equivalent (CO₂e). In the case of the bio-based article, the carbon footprint can be reduced by including a polymer material that is at least in part plant-based and that is recycled. The carbon footprint for a shoe including a bio-based foam midsole can be reduced by using recycled foam scrap from a midsole molding operation to make a bio-based heel counter or another bio-based part of the shoe.

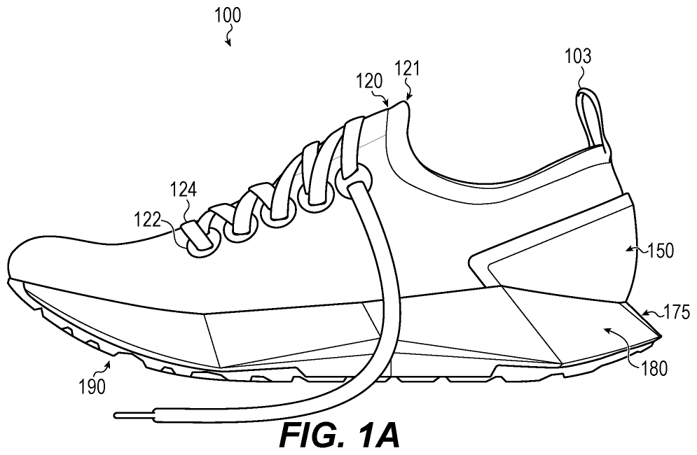

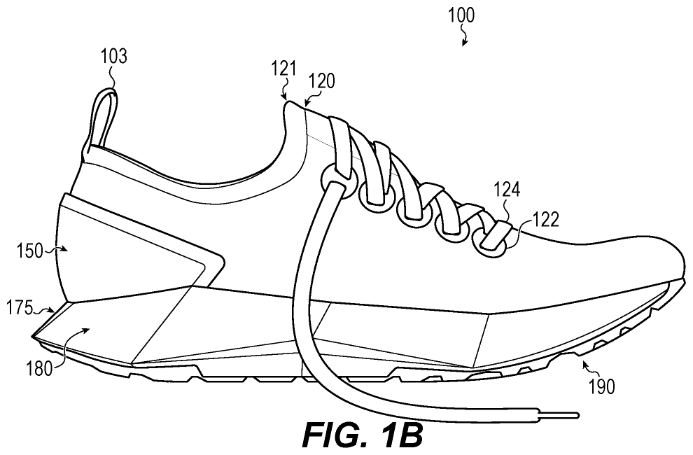

These and other embodiments are discussed below with reference to FIGS. 1A-4. However, those skilled in the art will readily appreciate that the detailed description given herein with respect to these figures is for explanatory purposes only and should not be construed as limiting.

FIGS. 1A and 1B show side views of a shoe 100. As shown in FIGS. 1A and 1B, the shoe 100 includes a shoe upper 120 that includes a collar 121. The shoe upper is alternately referred to as an upper portion of the shoe herein. The collar 121 defines an opening to a cavity of the shoe 100. The shoe 100 also includes sole 175. A top surface of the sole 175 may be attached to the shoe upper 120. As shown in the example of FIGS. 1A and 1B, the sole includes two sole components: a midsole 180 and an outsole 190. The example of FIGS. 1A and 1B is not limiting and in additional examples, the upper 120 need not include a collar 121 and/or the sole 175 need not include an outsole 190.

In the embodiment shown in FIGS. 1A and 1B, the shoe 100 includes a heel counter 150. The shoe 100 also includes laces 124, eyelets 122, and a loop 103. However in other embodiments the shoe need not include one or more of these features. As referenced from the front of the shoe, FIG. 1A shows a right view of the shoe 100 and FIG. 1B shows a left view of the shoe.

One or more parts of the shoe 100 may be made fully or mostly from a bio-based polymer material as discussed in more detail below with respect to at least the midsole 180 and the heel counter 150. The bio-based carbon content is determined from the ratio of “new” organic carbon (e.g., plant or agricultural-based carbon) to the total organic carbon in the product. The amount of bio-based carbon in the midsole, the heel counter, or other portion of the shoe (or in any such article) may be determined using a method such those described in ASTM D6866, ISO 16620-2, and CEN 16640. In some cases, a part for the shoe 100 may be referred to as “bio-based” when it has a bio-based carbon content greater than 20%, greater than 25%, greater than 30%, greater than 40%, greater than 50%, or within a range from 25% to 100%, from 40% to 60%, from 40% to 50%, from 50% to 100%, from 70% to 100%, or from 80% to 100%. Additional ranges for specific bio-based shoe components are provided below. In some cases, the bio-based polymer material is a bio-based thermoplastic material.

As examples, a bio-based polymer material may be based at least in part on a bio-based polyamide, a bio-based polyol, a bio-based polyolefin or another bio-based component. One or more of these bio-based components may be derived from a plant source. One example of a bio-based polyamide derived from a plant-based source is nylon 11, also referred to as polyamide 11, which can be produced from castor beans.

The midsole 180 is attached to the upper 120 and may be attached using an adhesive. In some embodiments, the midsole 180 may be formed of a polymer material, such as a bio-based thermoplastic material. In some cases, the percentage of the bio-based polymer(s) may be high enough so that the midsole itself is bio-based. As examples the bio-based carbon content of the midsole may be greater than 30%, greater than 40%, or greater than 50%. In additional examples, the bio-based carbon content of the midsole may be greater than 30% and less than 80%, greater than 30% and less than 70%, greater than 40% and less than 80%, greater than or equal to 40% and less than or equal to 70%, greater than or equal to 40% and less than or equal to 60%, greater than or equal to 40% and less than or equal to 50%, greater than 50% and less than 80%, or greater than 50% and less than 70%. The polymer material(s) used to make the midsole may have a low density and a high resiliency and may be in the form of a foam.

In embodiments, the midsole 180 includes a thermoplastic foam and can be made entirely of or from such a foam. In some cases, the thermoplastic foam may be recyclable. The thermoplastic foam may be recyclable by physical or mechanical methods rather than solely or primarily by chemical methods. For ease of recycling, the thermoplastic foam may be physically foamed rather than chemically foamed. In addition, the majority of crosslinks present in the thermoplastic foam may be reversible upon heating, such as the reversible crosslinks present in a thermoplastic elastomer. In additional cases, the thermoplastic foam may be bio-based. The thermoplastic foam may be a substantially closed cell foam.

In embodiments, the thermoplastic foam is a thermoplastic elastomer foam. Suitable thermoplastic elastomer materials for making the foam include, but are not limited to, one or more of a polyether-block-amide (PEBA) block copolymer thermoplastic elastomer, a thermoplastic polyester elastomer, also referred to as TPEE or as a copolyester thermoplastic elastomer, a thermoplastic olefin elastomer, or a thermoplastic polyurethane (TPU). The thermoplastic elastomer foam may also be formed from blends of one or more thermoplastic elastomer materials, such as a blend of different polyether-block-amide materials. As previously discussed, the thermoplastic elastomer material may be bio-based. As examples, a bio-based thermoplastic elastomer material may be based at least in part on a bio-based polyamide, a bio-based polyol, a bio-based polyolefin or another bio-based component.

The heel counter 150 of FIGS. 1A and 1B at least partially surrounds the shoe upper 120 in a heel region of the shoe 100. The heel counter 150 may at least partially surround a heel of a wearer and therefore provide improved foot stability to a rear of a wearer's foot (e.g., by stabilizing the heel and holding it in place within the shoe). The heel counter 150 may have a higher density than the midsole 180 in order to provide the desired level of stability, while still having a low enough density so that undue weight is not added to the shoe. The heel counter 150 may be attached to an exterior surface of the heel region of the shoe upper 120 using an adhesive.

In embodiments, the heel counter 150 includes, and can be exclusively made from, a recycled thermoplastic material. In some cases, the heel counter may include at least 50% by weight, at least 60% by weight, at least 60% by weight, at least 70% by weight, at least 80% by weight or at least 90% by weight of the recycled thermoplastic polymer material. In additional cases, these percentages may be by volume instead of by weight. As previously discussed, the recycled thermoplastic material may be bio-based, and the heel counter may also be bio-based. In some examples the bio-based carbon content of the recycled thermoplastic material and/or the heel counter may be greater than 30%, greater than 40%, or greater than 50%. In additional examples, the bio-based carbon content of the midsole may be greater than 30% and less than 80%, greater than 30% and less than 70%, greater than 40% and less than 80%, greater than or equal to 40% and less than or equal to 70%, greater than or equal to 40% and less than or equal to 60%, greater than or equal to 40% and less than or equal to 50%, greater than 50% and less than 80%, or greater than 50% and less than 70%.

In some embodiments, the recycled thermoplastic material is derived from scrap thermoplastic material from an operation of making another component of the shoe. For example, the recycled thermoplastic material may be derived from scrap thermoplastic material from an operation of making the midsole 180. In some cases, the recycled thermoplastic material is derived at least in part from scrap thermoplastic foam. The scrap thermoplastic material may be a scrap thermoplastic elastomer material, also referred to herein as scrap thermoplastic elastomer.

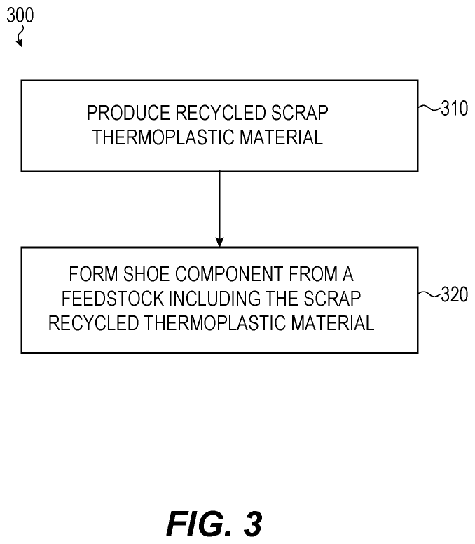

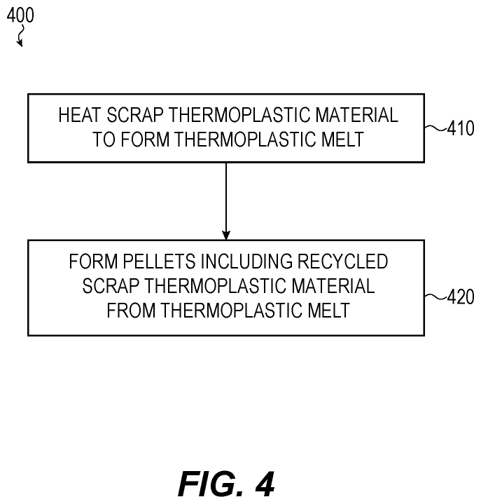

The recycled thermoplastic material may differ in density (e.g., due to porosity) or another property with respect to the thermoplastic foam. As explained in more detail with respect to FIGS. 3 and 4, gas originally present in the foam may escape during the recycling process and/or the molding process, so that the recycled thermoplastic material contains less gas than the melted foam. Therefore, the heel counter 150 including the recycled thermoplastic material may have a higher density than the midsole 180. In some cases, the density of the midsole 180 may be from 10% to 30% of the density of the heel counter 150. As a specific example, the density of a PEBA-based midsole may range from 0.1 g/cm³ to 0.3 g/cm³ while the density of the heel counter may range from 0.9 g/cm³ to 1.1 g/cm³. The heel counter may be fully or substantially dense (e.g., less than 10 vol % or less than 5 vol % porosity).

The internal structure of the heel counter or other article including the recycled thermoplastic material may differ from the internal structure of the thermoplastic foam. For example, an internal structure of the heel counter may lack the cellular network structure that is characteristic of many foams due to removal of substantial amounts of gas from the scrap foam during the recycling and/or the molding process. In some cases, the internal structure of the heel counter lacks distinct interparticle boundaries due to melting and merging of the particles of the scrap thermoplastic polymer during the recycling and/or the molding process.

The outsole 190 typically has an upper surface that is attached to the midsole 180 and a lower surface that defines a tread portion of the shoe. The tread portion may include grooves to provide flexibility to the shoe 100. In some cases, the outsole 190 may be attached to the midsole 180 with an adhesive. The outsole may be formed from one or more polymer materials such as natural or synthetic rubber, a polyether-block-amide (PEBA) block copolymer thermoplastic elastomer, a copolyester thermoplastic elastomer, a thermoplastic or thermoset polyurethane, or an ethylene vinyl acetate. In additional cases, the outsole may be formed from one or more bio-based polymer materials.

In some embodiments, the shoe upper 120 may be formed wholly or in part from a knit textile. The knit textile may be a continuous textile and, in some cases, may define multiple regions with different textile properties. Examples of these textile properties may include breathability, amount of stretch, yarn composition, knit pattern, and the like. In some cases, the textile may be formed using one or more types of yarn. The yarn may be formed from one or more natural or synthetic fibers twisted or otherwise bound together. Examples of fibers that may be used in the yarn include wool, silk, cotton, linen, hemp, and regenerated cellulose fibers such as lyocell fibers, polyester, nylon, and the like. Regenerated cellulose fibers can be made from sources like eucalyptus, bamboo, and birch trees. In some cases, some or all of any synthetic fibers included in the yarn are recycled synthetic fibers, such as recycled polyester, recycled nylon, or the like. In some cases, the knit textile includes a yarn including from 50% to 75% lyocell fibers and from 25% to 50% recycled polyester fibers or from 60% to 75% lyocell fibers and from 25% to 40% recycled polyester fibers. The lyocell fibers and the recycled polyester fibers may make up 95% or more of the yarn. In some examples, the lyocell/recycled polyester yarn may make up 80% to 95% or 90% to 95% of the knit upper as a whole or of the portion of the knit upper excluding the collar 121. In some cases, the knit shoe upper may also include an elastomer such as spandex to provide stretch. In some embodiments, the collar 121 may include a greater percentage of the elastomer than another portion of the shoe upper. In some examples these percentages may be by weight while in other cases these percentages may be by volume.

As shown in FIGS. 1A and 1B, the shoe 100 includes eyelets 122 and a shoelace 124 passing through the eyelets. As examples, the eyelets may be inserted into the shoe upper 120 or may be attached to the shoe upper by sewing, an adhesive, high frequency welding, or the like. The eyelets 122 may be formed from a bio-based polymer or a recycled polymer, such as a bio-based or recycled thermoplastic polyurethane. The shoelace 124 may include a bio-based polymer or a recycled polymer, such as a recycled polyester, a recycled nylon, or the like. In some cases, the shoelace 124 may also include an elastomer such as spandex to provide stretch. The shoe of FIGS. 1A-1B also includes a loop 103 positioned at a rear portion of the opening of the shoe. The loop 103 may assist a wearer to insert a foot into the shoe. The loop 103 may be formed from a bio-based polymer or a recycled polymer, such as a recycled polyester, a recycled nylon, or the like.

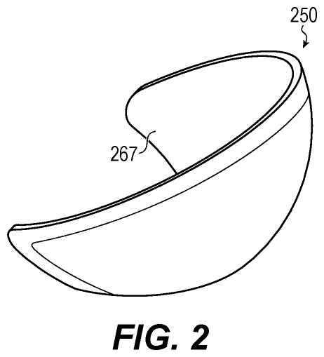

FIG. 2 shows a heel counter 250 for a shoe. The heel counter 250 may be an example of the heel counter 150 of FIGS. 1A and 1B. As shown in FIG. 2, the heel counter 250 defines an inner surface 267 that may be attached to a portion of a shoe upper. The inner surface 267 may be curved to match a curved shape of the shoe upper. For example, the inner surface 267 may define a concave portion and the back end of the shoe upper may fit within the concave portion. As previously discussed with respect to the heel counter 150, the heel counter 250 may at least partially surround the heel of a wearer and therefore provide stability to a rear of a wearer's foot. The heel counter 250 may be formed of similar materials and may have similar properties as previously described with respect to the heel counter 150 and that description is not repeated here.

FIG. 3 shows a flow chart of a process 300 for making a shoe component. The shoe component may be formed at least in part from scrap resulting from an operation of forming another shoe component. For example, the other shoe component may be a sole component, such as foam component of the sole and the shoe component formed in the process 300 may be other than a sole component. As a particular example, the shoe component formed in the process 300 may be a heel counter, which is formed at least in part from scrap from an operation of making the foam component of the shoe.

The shoe component formed in the process 300 may have a form that is different than that of the other shoe component. For example, the shoe component formed in the process 300 may be substantially dense while the other shoe component is in the form of a foam. Therefore, the shoe component formed by the process 300 may have a density that is greater than that of the other shoe component. For convenience, the shoe component formed in the process 300 may be referred to herein as a second shoe component and the other shoe component may be referred to herein as a first shoe component. Each of the first and the second shoe components may be bio-based. The heel counter may be similar in shape, function, and/or materials to the heel counters 150 and 250 and that description is not repeated here.

The process 300 begins with an operation 310 of producing a recycled scrap thermoplastic material. As previously discussed, the recycled scrap material may be formed from a scrap thermoplastic material, which may result from another industrial operation. The scrap thermoplastic material may include a thermoplastic foam. In some cases, the scrap thermoplastic material may be primarily or completely thermoplastic foam. The scrap thermoplastic material may be ground, chopped, pelletized, shredded, separated, or otherwise broken down (whether mechanically or by hand) as part of the operation 310.

The scrap thermoplastic material may be any of the thermoplastic materials previously described with respect to the midsole 180. In some examples, the scrap thermoplastic material is bio-based. In some cases, the scrap thermoplastic material may be formed from a mixture of two or more polymer components. In specific examples, the scrap thermoplastic material is formed from a mixture of one or more bio-based polymer components. In some embodiments, the mixture does not include a cross-linking agent or a chemical blowing agent.

The other industrial operation may be a molding operation. In some cases, the molding operation is an injection molding operation. For example, the molding operation may be a molding operation for making a sole component of a shoe, such as a midsole molding operation. The molding operation may generate scrap material such as runner material, sprue material, defective parts, and the like. Scrap material may alternately be referred to herein as waste material or waste. In some cases, the operation 310 of producing the recycled scrap thermoplastic material consumes all or substantially all of the scrap material that is generated during one or more molding operations.

The recycled scrap thermoplastic material may be different in form than the scrap thermoplastic material. For example, the scrap thermoplastic material may include scrap thermoplastic foam and the recycled scrap thermoplastic material may have a higher density than the scrap thermoplastic material. In some cases, the scrap thermoplastic material may be primarily or completely thermoplastic foam. The thermoplastic foam may be physically foamed, such as a supercritically foamed thermoplastic material.

The operation 310 of producing the recycled scrap thermoplastic material includes heating the scrap thermoplastic material to a temperature at or above its melting point to form a thermoplastic melt. The thermoplastic melt may be a mixture of multiple components, such as multiple polymer components (e.g., when the first shoe component is formed from a mixture of two or more polymer materials).

During formation of the thermoplastic melt, the scrap thermoplastic foam loses its cellular foam structure and gas formerly trapped within the cellular foam structure is released. In some cases, most or all of the gas released during melting of the scrap thermoplastic foam escapes from the thermoplastic melt during the operation 310.

The thermoplastic melt may be formed into pellets or another suitable shape for the operation 320. In some examples, the thermoplastic melt may be extruded as part of a pelletizing operation. Because the scrap thermoplastic material has been remelted and reshaped during the operation 310, the recycled scrap thermoplastic material may have a different form than the scrap thermoplastic material. A more detailed description of an operation of making a recycled scrap thermoplastic material is described with respect to FIG. 4 and the description provided with respect to FIG. 4 is generally applicable herein.

The process continues with an operation 320 of forming the shoe component from a feedstock including the recycled scrap thermoplastic material produced in the operation 310. The shoe component may be formed by a molding operation, such as an injection molding operation or another suitable molding operation. In some embodiments, the feedstock is melted during the operation 320.

The feedstock for the operation 320 comprises the recycled scrap thermoplastic material. In some cases, the feedstock may be wholly formed from scrap thermoplastic material while in other cases the feedstock may be predominantly formed from scrap thermoplastic material. As a particular example, the feedstock may be wholly or predominantly formed from scrap thermoplastic foam. A feedstock predominantly formed from scrap thermoplastic material may be formed from at least 50% recycled scrap thermoplastic material, at least 60% recycled scrap thermoplastic material, at least 70% recycled scrap thermoplastic material, at least 80% recycled scrap thermoplastic material, or at least 90% recycled scrap thermoplastic material. In some cases, these percentages are weight percentages while in other cases these percentages are volume percentages. In some embodiments, an additional thermoplastic material, such as a virgin thermoplastic material, may be included in the feedstock. For example, a virgin thermoplastic material may make up the balance of the feedstock when sufficient scrap thermoplastic material is not available.

The shoe component formed during the process 320 may be described as being formed from the feedstock material. When the feedstock material is wholly formed from recycled scrap thermoplastic material, the shoe component may be described as being formed from the recycled scrap thermoplastic material. When the feedstock material is predominantly formed from recycled scrap thermoplastic material, the shoe component may be described as being predominantly formed from the recycled scrap thermoplastic material. The shoe component may have the same percentage of recycled scrap thermoplastic material as the feedstock. In some embodiments the second shoe component includes at least 50% by weight, at least 60% by weight, at least 60% by weight, at least 70% by weight, at least 80% by weight or at least 90% by weight of the recycled thermoplastic polymer material. In certain embodiments, these percentages may be by volume rather than by weight. As previously discussed, in some embodiments, the second shoe component is a heel counter of a shoe.

In some embodiments, the process 300 may include one or more additional operations. In some examples, the process may include an operation of providing scrap thermoplastic material that precedes the operation 310. In some examples, the process may include an operation of forming a first shoe component from foamed thermoplastic material and scrap thermoplastic material from this operation may be used in the operation 310.

FIG. 4 shows a flow chart of a process 400 for making a recycled scrap thermoplastic material. The recycled scrap thermoplastic material may be used in the process of FIG. 3.

The process 400 begins with an operation 410 in which scrap thermoplastic material is heated to form a thermoplastic melt. As previously discussed, the scrap thermoplastic material may include a thermoplastic polymer foam. The scrap thermoplastic material is heated to or above its melting point to form the thermoplastic melt. As previously described, the scrap thermoplastic material may be scrap foam from another industrial operation. For example, the scrap thermoplastic material may be scrap foam from a molding operation for making the midsole of a shoe. As another example, the scrap thermoplastic material may be derived from a post-consumer scrap material.

The process 400 also includes an operation 420 of forming pellets from the thermoplastic melt. The pellets are therefore formed, at least in part, from a recycled scrap thermoplastic material. As previously mentioned, the operation of forming the pellets may help remove any remaining gas from the thermoplastic melt, such as during extrusion of the thermoplastic melt. In some cases, the recycled thermoplastic material has properties that are substantially the same as those of a source thermoplastic material used to make the foam. In additional cases, the recycled thermoplastic material has one or more properties, such as the crystallinity or the melt index, which differ from those of the source thermoplastic material.

The process 400 may produces a recycled thermoplastic material at least in part from a thermoplastic foam. The recycling of the thermoplastic foam may occur by physical or mechanical methods rather than solely or primarily by chemical methods. In contrast, some conventional chemical recycling methods for polymers break down polymers into their chemical constituents.

The disclosure also provides methods for making a shoe. In some cases, a method for making a shoe may include one or more operations of assembling components of the shoe. One or more of the shoe components may include a recycled scrap thermoplastic material as described herein. For example, the heel counter may include a recycled scrap thermoplastic material and may be assembled with an upper portion of the shoe. A foam midsole component may also be assembled with the upper portion of the shoe. As previously discussed, each of the thermoplastic foam for the midsole, the recycled thermoplastic material, and the article may be bio-based.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A shoe, comprising:
an upper portion;
a sole having a top surface that is attached to the upper portion, the sole comprising a foam component formed from a bio-based thermoplastic material; and
a heel counter attached to an exterior surface of the upper portion and comprising a recycled bio-based thermoplastic material.

2. The shoe of claim 1, wherein the heel counter has a density greater than a density of the foam component.

3. The shoe of claim 2, where the bio-based thermoplastic material is a bio-based polyether-block-amide (PEBA) block copolymer thermoplastic elastomer.

4. The shoe of claim 2, wherein the heel counter lacks a cellular network structure.

5. The shoe of claim 2, wherein the heel counter predominantly comprises the recycled bio-based thermoplastic material.

6. The shoe of claim 1, wherein:
the foam component is a midsole of the shoe; and
the shoe further comprises an outsole attached to the midsole and defining a tread portion of the shoe.

7. The shoe of claim 6, wherein the recycled bio-based thermoplastic material is at least partially derived from scrap foam from a midsole molding operation.

8. A shoe, comprising:
an upper portion;
a sole having a top surface that is attached to the upper portion, the sole comprising a foam component formed of a thermoplastic elastomer; and
a heel counter attached to an exterior surface of the upper portion and formed at least in part from scrap thermoplastic elastomer.

9. The shoe of claim 8, wherein the scrap thermoplastic elastomer is a thermoplastic elastomer foam.

10. The shoe of claim 9, wherein a density of the foam component is from 10% to 30% of a density of the heel counter.

11. The shoe of claim 9, wherein the thermoplastic elastomer has a bio-based carbon content ranging from 40% to 60%.

12. The shoe of claim 9, wherein each of the thermoplastic elastomer and the scrap thermoplastic elastomer is a polyether-block-amide (PEBA) block copolymer thermoplastic elastomer.

13. The shoe of claim 12, wherein the thermoplastic elastomer comprises nylon 11 blocks.

14. The shoe of claim 8, wherein the heel counter has an internal structure that lacks interparticle boundaries.

15. A method comprising:
producing a recycled scrap thermoplastic material; and
forming a shoe component from a feedstock including the recycled scrap thermoplastic material.

16. The method of claim 15, where the recycled scrap thermoplastic material is derived at least in part from scrap thermoplastic foam.

17. The method of claim 16, wherein the operation of producing the recycled scrap thermoplastic material comprises:
forming a melt including scrap thermoplastic material; and
forming pellets of the feedstock from the melt.

18. The method of claim 16, wherein:
the shoe component is a second shoe component; and
the scrap thermoplastic foam is generated by an operation of forming a first shoe component.

19. The method of claim 18, wherein the first shoe component is a sole component and the second shoe component is a heel counter.

20. The method of claim 19, further comprising assembling the sole component and the heel counter with an upper portion of a shoe.
